(19) United States
(12) Patent Application Publication
(10) Pub. No.: US 2012/0001936 A1
(43) Pub. Date: Jan. 5, 2012

(54) MAP INFORMATION PROCESSING APPARATUS, MAP INFORMATION PROCESSING METHOD, MAP INFORMATION PROCESSING PROGRAM AND RECORDING MEDIUM

(75) Inventors: Tetsuya Kurata, Tokyo (JP); Wazo Fukuhara, Foster City, CA (US)

(73) Assignees: INCREMENT P CORPORATION, Kanagawa (JP); PIONEER CORPORATION, Kanagawa (JP)

(21) Appl. No.: 13/148,425

(22) PCT Filed: Feb. 6, 2009
(86) PCT No.: PCT/JP2009/052107

§ 371 Date: Aug. 8, 2011

(51) Int. Cl. G09G 5/377

(52) U.S. Cl. 345/629

(57) ABSTRACT

Provided are a map information processing device, a map information processing method, a map information processing program, and a recording medium by which useful information such as address information can be given to an architectural structural shape efficiently with high accuracy while the time and cost are drastically reduced. First map data configured to include address information indicating the address of a building or a lot and dot coordinate information indicating dot coordinates for representing the position of the building or the lot as a dot and second map data configured to include shape coordinate information indicating a coordinate group for representing the planar outer shape of the building or the lot are read, it is judged from the dot coordinate information included in the first map data and the shape coordinate information included in the second map data whether or not the address information corresponding to the dot coordinate information and the shape coordinate information are associated with each other, and when it is judged by an association judging means that both are associated with each other, association information for associating the address information corresponding to the dot coordinate information and the shape coordinate information with each other is generated.

### TECHNICAL FIELD

The present invention relates to a map information processing apparatus that processes map information for displaying a map, and the other.

### BACKGROUND OF THE INVENTION

There has recently been known all over the world a map displaying system through which map data are supplied from a map information web site (a server) on a network of Internet or the like to a client's terminal. Map information on Japan supplied from map information web sites in Japan is well-organized in comparison with foreign countries. A contour of a house, etc. is usually displayed, for example together with a road link, on a map of Japan. Respective house-contour data include information on name data, classification data, adjacent road data, address data, etc., as disclosed in Patent Document 1. This permits to display various kinds of information in the vicinity of a house as displayed on a map, and an operation of inputting an address by a user makes it possible to retrieve a certain house-contour data.
Patent Document 1: Japanese Patent Provisional Publication No. H09-152831

### DISCLOSURE OF THE INVENTION

### Subject to be Solved by the Invention

There is known map data provided from a map information web site in foreign countries, for example, map data of the United States of America provided from a map information web site therein, in which map data a house-contour is displayed on a map. However, valuable information including address data (address information) is not associated with the above-mentioned house-contour in a different manner from the map data of Japan as described above. Therefore, there is no sufficient information, which is to be supplied to a user on a map, and a specific house-contour cannot be retrieved by inputting an address. Hence, there is a need to associate valuable information including address information and the like with the house-contour in such a map data as described above.

However, associating the address information and the like with each of the house-contours in such a map data requires a great deal of time and cost, thus causing a problem. Especially, such a problem will occur notably in the map of a country such as the United States of America having a vast area of land.

The present invention has therefore a problem to solve the above-described problems as one of problems to be solved. An exemplary object of the present invention is to provide a map information processing apparatus, a map information processing method, a map information processing program and a recording medium, which permit to provide the house-contour with valuable information such as address information and the like in an effective manner and with a high degree of accuracy, while remarkably minimizing time and cost as required.

### Means to Solve the Subject

In order to attain the aforementioned object, the map information processing apparatus claimed in claim 1 comprises: a reading unit that reads first map data comprising address information indicative of an address of a building or a parcel of land, and point-coordinate information indicative of coordinates of a point by which a position of the building or the parcel of land is represented as a dot; and second map data comprising contour-coordinate information indicative of a group of coordinates by which a planar contour of the building or the parcel of land is represented; an association judgment unit that judges, based on said point-coordinate information included in the first map data and said contour-coordinate information included in the second map data, as to whether or not an association between said address information corresponding to said point-coordinate information and said contour-coordinate information is to be made; and an association information generating unit that generates association information based on which the association between the address information corresponding to the point-coordinate information and the contour-coordinate information is to be made, in case where the association judgment unit judges the association to be made.

The map information processing method claimed in claim 15 comprises the steps of: reading first map data comprising address information indicative of an address of a building or a parcel of land, and point-coordinate information indicative of coordinates of a point by which a position of the building or the parcel of land is represented as a dot; and second map data comprising contour-coordinate information indicative of a group of coordinates by which a planar contour of the building or the parcel of land is represented; judging, based on said point-coordinate information included in the first map data and said contour-coordinate information included in the second map data, as to whether or not an association between said address information corresponding to said point-coordinate information and said contour-coordinate information is to be made; and generating association information based on which the association between the address information corresponding to the point-coordinate information and the contour-coordinate information is to be made, in case where the association judgment unit judges the association to be made.

The map information processing program claimed in claim 16 causes a computer to execute the steps of: reading first map data comprising address information indicative of an address of a building or a parcel of land, and point-coordinate information indicative of coordinates of a point by which a position of the building or the parcel of land is represented as a dot; and second map data comprising contour-coordinate information indicative of a group of coordinates by which a planar contour of the building or the parcel of land is represented; judging, based on said point-coordinate information included in the first map data and said contour-coordinate information included in the second map data, as to whether or not an association between said address information corresponding to said point-coordinate information and said contour-coordinate information is to be made; and generating association information based on which the association between the address information corresponding to the point-coordinate information and the contour-coordinate information is to be made, in case where the association judgment unit judges the association to be made.

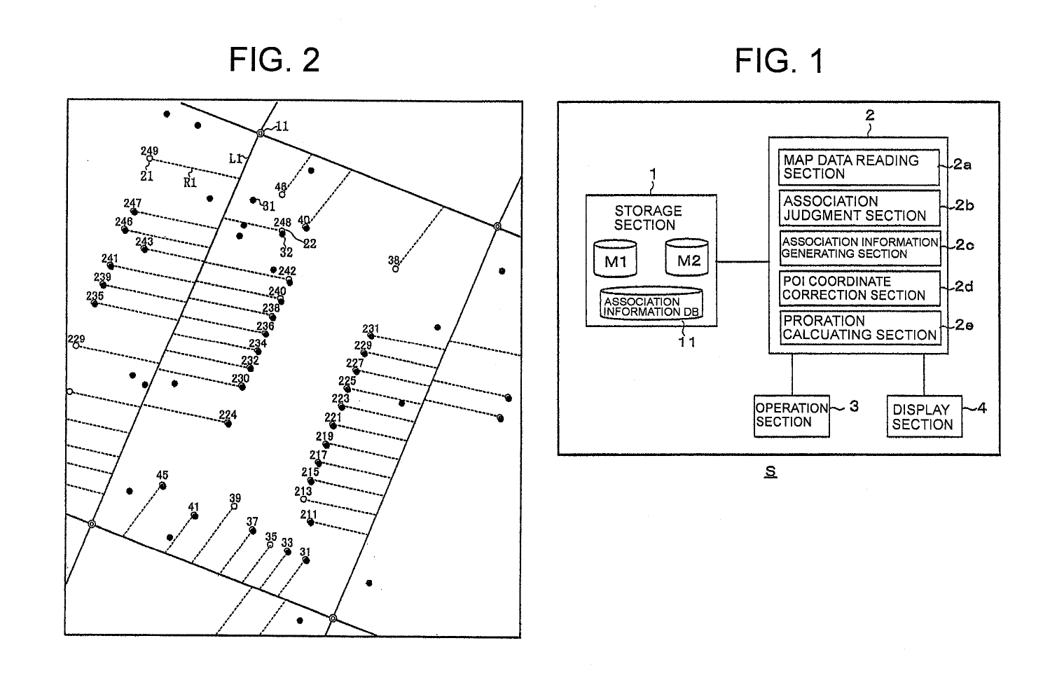

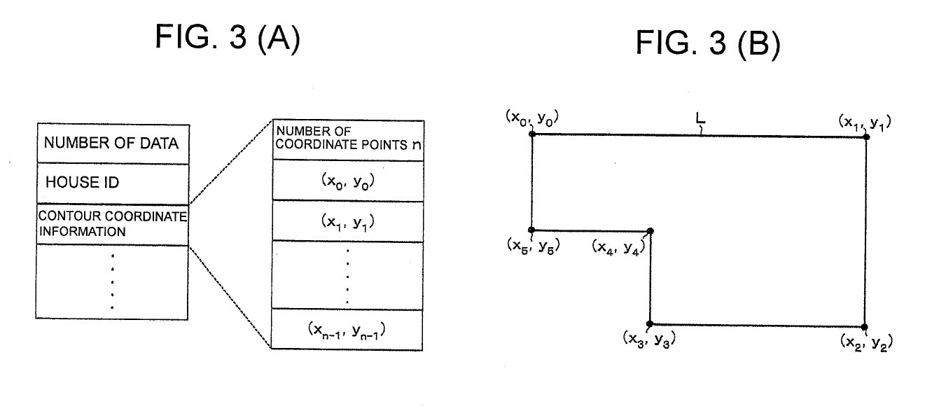

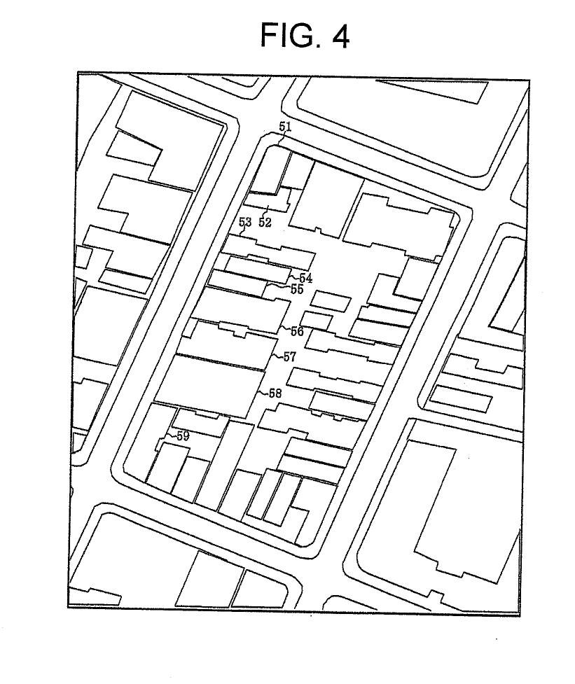

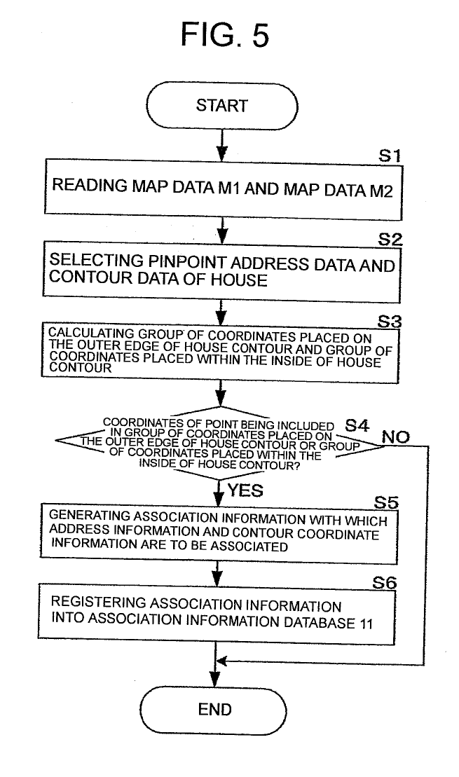

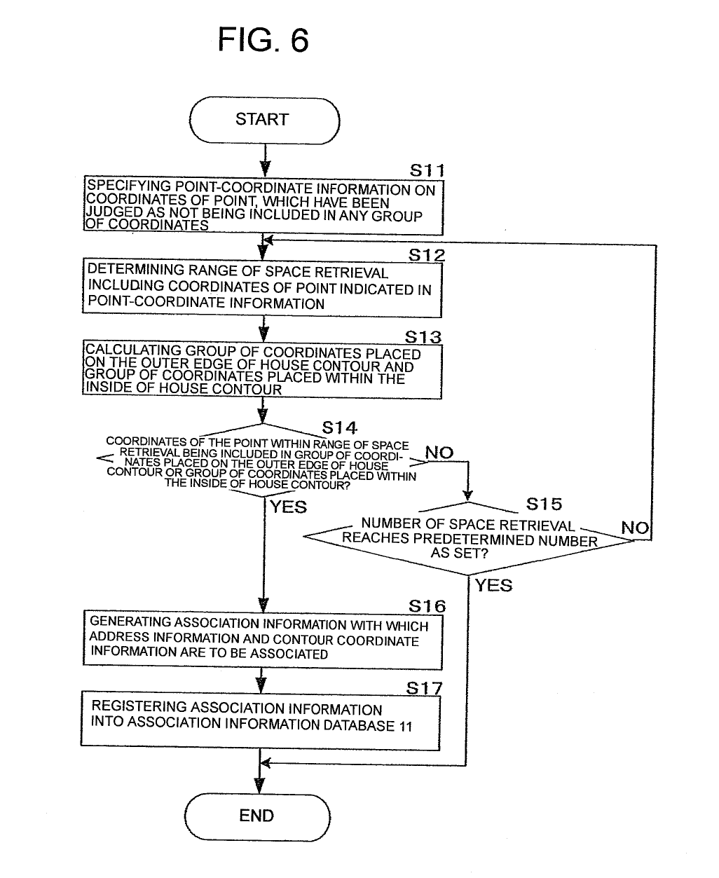

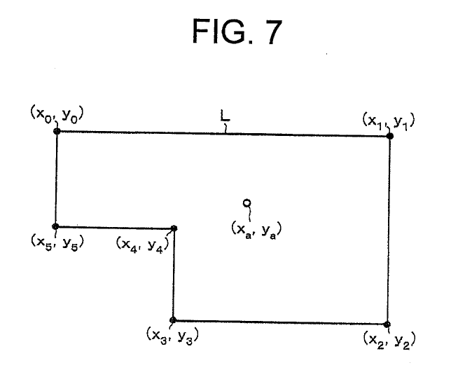

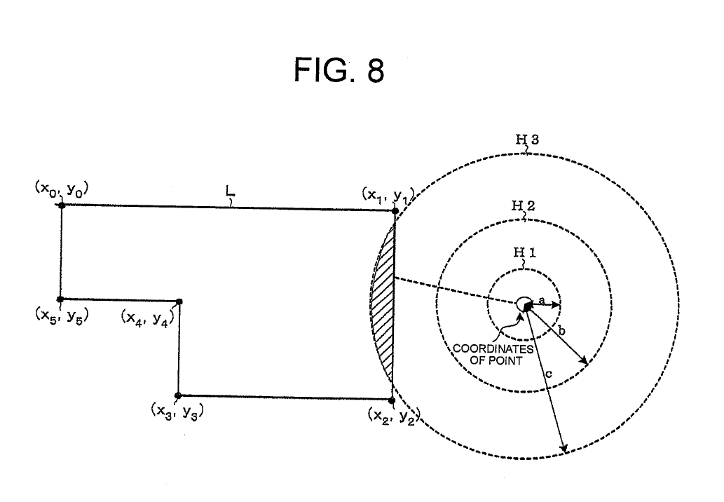

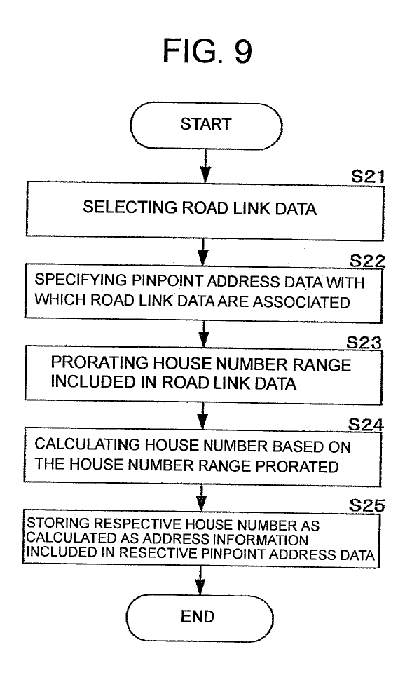

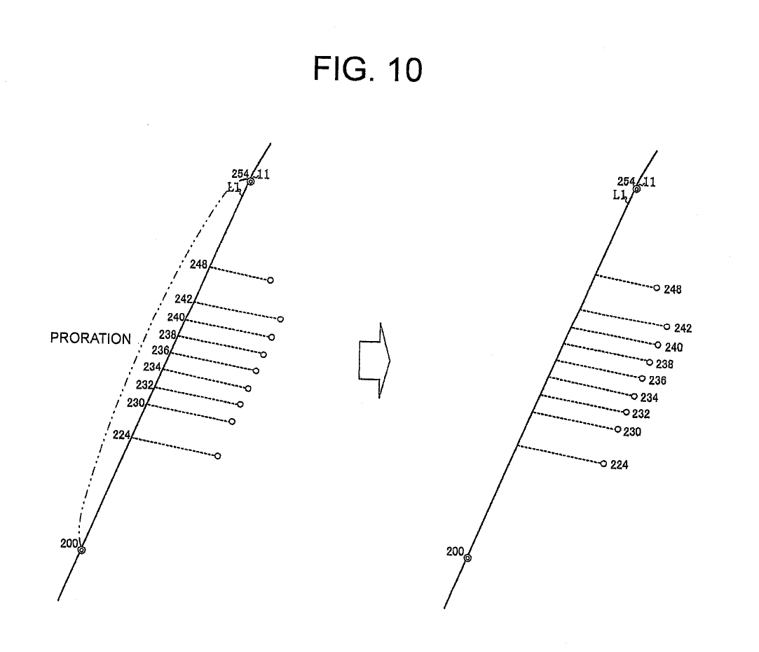

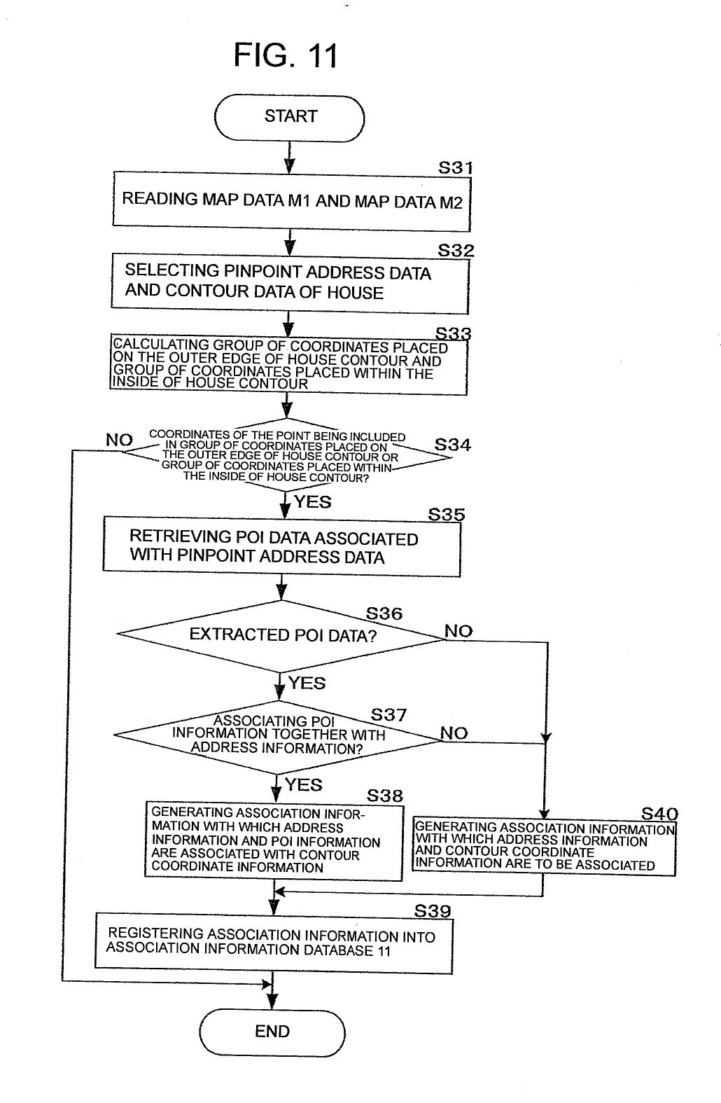

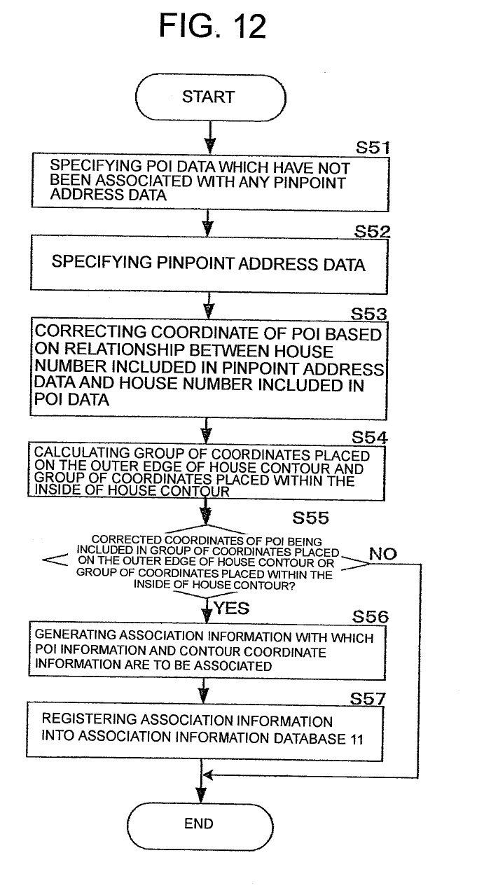

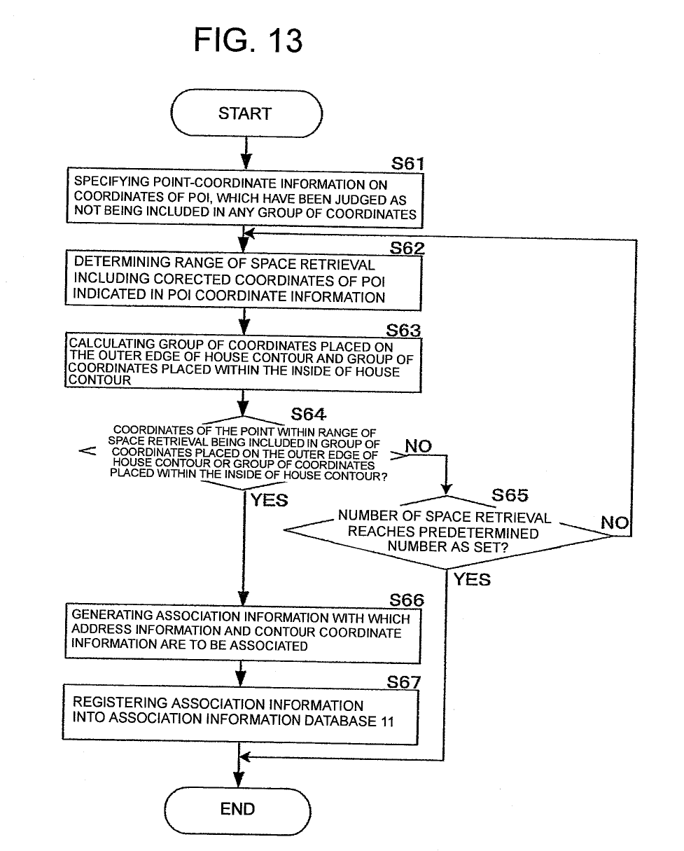

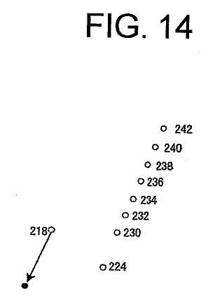

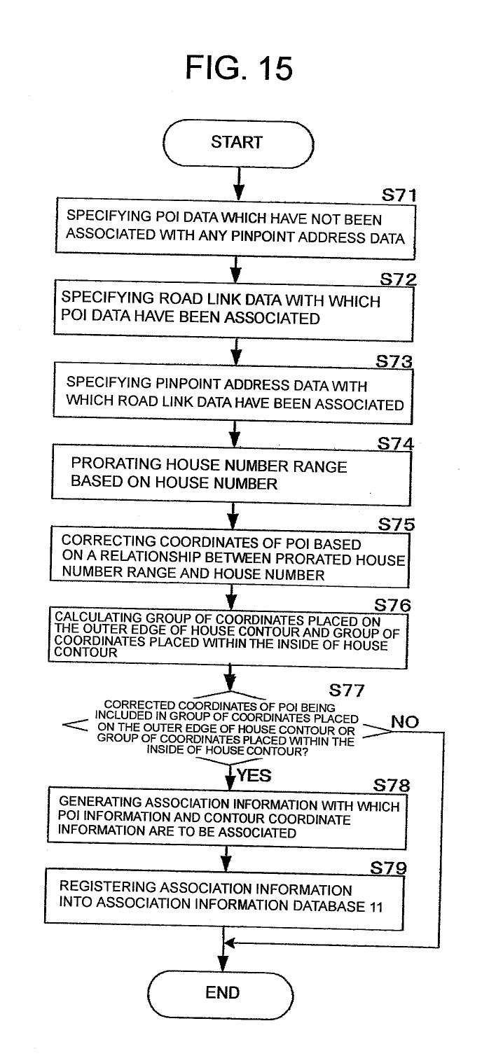

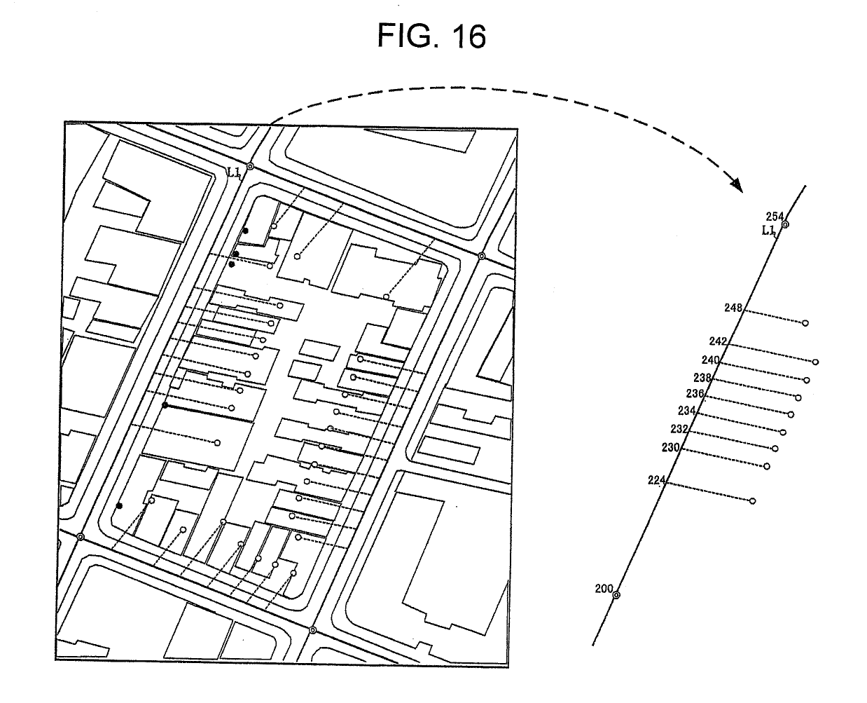

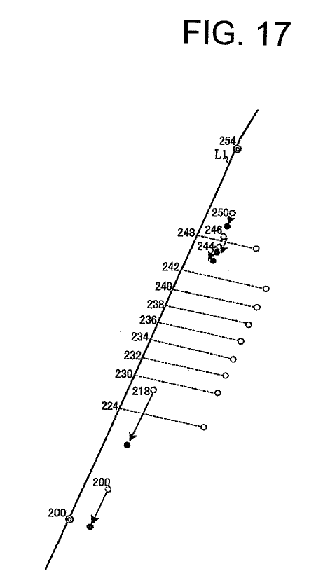

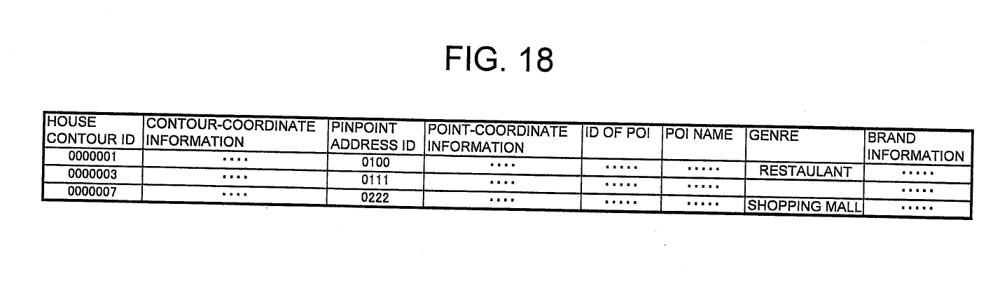

### BRIEF DESCRIPTION OF THE DRAWINGS

[FIG. 1] is a view illustrating a schematic configuration example of a map information processing apparatus according to the embodiment of the present invention;

[FIG. 2] is a view illustrating an image in which a building or a parcel of land, a road link and a position of POI are displayed on a coordinate plane;

[FIG. 3] (A) is a view illustrating an example of a data structure of contour data of a house-contour, and (B) is a view illustrating an example of the house-contour;

[FIG. 4] is a view illustrating an image in which a position of the house-contour is displayed on a coordinate plane;

[FIG. 5] is a flowchart showing an example of a map information processing by an arithmetic processing section 2 in Example No. 1, etc.;

[FIG. 6] is a flowchart showing an example of a map information processing by an arithmetic processing section 2 in Example No. 1, etc.;

[FIG. 7] is a view illustrating an example of a relationship between coordinates of a point and the group of coordinates that are placed on an outer edge of the planar contour and within an inside of the planar contour;

[FIG. 8] is a schematic view showing an example of a gradually expanding range of a space retrieval;

[FIG. 9] is a flowchart showing an example of a map information processing by an arithmetic processing section 2 in Example No. 2;

[FIG. 10] is a schematic view showing a state in which a house number is assigned to a building or a parcel of land based on house number ranges;

[FIG. 11] is a flowchart showing an example of a map information processing by an arithmetic processing section 2 in Example No. 3;

[FIG. 12] is a flowchart showing an example of a map information processing by an arithmetic processing section 2 in Example No. 3;

[FIG. 13] is a flowchart showing an example of a map information processing by an arithmetic processing section 2 in Example No. 3;

[FIG. 14] is a schematic view showing a state in which the coordinates of the POI are corrected based on the house number;

[FIG. 15] is a flowchart showing an example of a map information processing by an arithmetic processing section 2 in Example No. 4;

[FIG. 16] is a schematic view showing a state in which the house number range is prorated;

[FIG. 17] is a schematic view showing a state in which the coordinates of the POI are corrected; and

[FIG. 18] is a view showing an example of information registered on an association information database 11.

### EXPLANATION OF THE REFERENCE NUMERALS

1 storage section
2 arithmetic processing section
2a map data reading section
2b association judgment section
2c association information generating section
2d POI coordinate correction section
2e proration calculating section
3 operation section
4 display section
S map information processing apparatus

### BEST MODE FOR CARRYING OUT THE INVENTION

Now, embodiments of the present invention will be described below with reference to the accompanying drawings.

A map information processing apparatus according to the embodiment of the present invention is characterized in that two kinds of map data, i.e., the first map data (hereinafter referred to as the “map data M1”) and the second map data (hereinafter referred to as the “map data M2”) and an association is made between address information, as included in the map data M1, indicative of an address of a building or a parcel of land, and contour-coordinate information, as included in the map data M2, indicative of a group of coordinates by which a planar contour of the building or the parcel of land is represented.

First, description will be given below of a structure and function of the map information processing apparatus according to the embodiment of the present invention, with reference to FIG. 1, etc.

FIG. 1 is a view illustrating a schematic configuration example of the map information processing apparatus according to the embodiment of the present invention.

As shown in FIG. 1, the map information processing apparatus S includes a storage section 1 having a hard disc drive, etc., an arithmetic processing section 2 having a CPU, a RAM, a ROM, etc., an operation section 3 having an mouse and a keyboard, etc., that receive instruction from a user, and a display section 4 having a display screen.

The storage section 1 stores the map data M1 and the map data M2. In addition, the storage section 1 creates association information database 11 on which association information is registered.

Now, the map data M1 will be described below.

The map data M1 includes pinpoint address data, road link data (an example of road link information) and POI (Point of interest) data. The map data M1 do not necessarily include the road link data and the POI data.

The pinpoint address data include text data having a country name, a state name, a city name, a ZIP (Zone Improvement Plan) code, a street name, and the other; point-coordinate information indicative of coordinates of a point by which an actual position of a building or a parcel of a land is represented as a dot; and an pinpoint address ID (identification information).

The pinpoint address data are set for each of the building or the parcel of land, and the respective pinpoint address data are identified by a unique pinpoint address ID.

The country name, the state name, the city name, the ZIP (Zone Improvement Plan) code and the street name are examples of address information indicative of the address of the building or the parcel of land. Such address information additionally includes a house number with which the building such as a house may peculiarly be identified.

The coordinates of a point as indicated by the point-coordinate information may be represented for example by latitude and longitude. The point-coordinate information is indicative of the coordinates of a point by which the position is represented as the dot based on a position of the building, which actually exists or once existed, or the parcel of land, which is actually demarcated or was once demarcated. The above-mentioned coordinates of the point are determined by reliable data such as field survey data, aerial photograph data, etc., thus being extremely accurate.

The road link data include data having a road type, a link type, a regulation, a street name, a house number, etc.; and a road link ID.

The road link data are set for each of the road links and the respective road link data are identified by a unique road link ID. The road links are elements of which a road indication is composed and the respective road link branches off for example at a fork in the road (a connection point).

The road link data are associated with the pinpoint address data. For example, the road link data for a certain road link are associated with the pinpoint address data for a building or a parcel of a land, which is placed in the vicinity of this road link. Such an association is made based on the respective ID or street name.

The position of the road link is determined by the point-coordinate information included in the pinpoint address data as associated with this road link data.

The house number range is information indicative of a range of the house number, which is to be assigned to a building placed in the vicinity of the road link. The house number is calculated through a proration calculation based on the house number range and then assigned to it. The house number as assigned is incorporated as address information into the pinpoint address data for the building or the parcel of land.

The POI data include text data (an example of the POI information) having a name of a POI such as facilities (for example, a restaurant, a shopping mall, a gas station, etc.), a genre (a category), a brand information, a street name, a house number and the other; and POI coordinate information indicative of coordinates of the POI by which the position of the POI is represented as a dot; and an ID of the POI.

The POI data are set for each of the POIs, and the respective POI data are identified by a unique ID of the POI.

The POI data are associated with the road link data. For example, the POI data for a certain POI are associated with the road link data for a road link, which is placed in the vicinity of this POI. Such an association is made based on the respective ID or street name.

The street name and the house number included in the POI data are examples of address information indicative of the address of the POI.

The POI data include data as associated with the pinpoint address data and those as not associated with them. Such an association is made based on the respective ID or the coordinate information.

The coordinates of a POI as indicated by the POI coordinate information may be represented for example by latitude and longitude. The coordinates of the POI range from the high-accurate to the less-accurate. For example, in case where the POI data are associated with the pinpoint address data and the coordinates of the POI coincide with the coordinates of the point, the coordinates of the POI are extremely high-accurate. On the other hand, in case where the POI data are not associated with the pinpoint address data and the approximate coordinates of the POI are provided, the coordinates of the POI are less-accurate.

Now, a relationship between the building or the parcel of land, the road link and a position of the POI will be described with reference to FIG. 2.

FIG. 2 is a view illustrating an image in which the building or the parcel of land, the road link and the position of POI are displayed on a coordinate plane. In an example as shown in FIG. 2, a white circle is a mark indicative of the building or the parcel of land (e.g., “21” in the figure) and a black circle is a mark indicative of a POI (e.g., “31” in the figure). The position of the mark indicative of the building or the parcel of land corresponds to the coordinates of the point indicated by the point-coordinate information included in the pinpoint address data, and the position of the mark indicative of the POI corresponds to the coordinates of the POI indicated by the POI coordinate information included in the POI data. The number indicated in the vicinity of the mark indicative of the respective building or parcel of land is the house number (the building indicated by the mark 21 has the house number of “249”).

In addition, the solid line denotes a road link (e.g., “L1” in the figure), a double circle denotes a node connecting the road links to each other (e.g., “11” in the figure), a broken line (e.g., “R1” in the figure) denotes an association between the building or the parcel of land and the road link, which is represented based on the association between the pinpoint address data and the road link data.

A plurality of marks indicative of the POIs includes the marks, which overlap the mark indicative of the building or the parcel of land, and the other mark, which do not overlap such a mark. For example, the mark 31 indicative of the POI does not overlap any mark indicative of the building or the parcel of land, and the position of this POI is less-accurate. To the contrary, the mark 32 indicative of the POI overlaps the mark 22 indicative of the building or the parcel of land, and the position of this POI is high-accurate.

Now, the map data M2 will be described.

The map data M2 include contour data by which a planar contour of a building, a parcel of land, a green space, a water system, a road width and the like may be represented. In this embodiment of the present invention, description will be given especially of a planer contour of a building or a parcel of land (hereinafter referred to as the “house-contour”).

The contour data of the house-contour include contour-coordinate information indicative of a group of coordinates by which the house-contour is represented.

The contour data of the house-contour is set for each of the house-contours and the contour data of the respective house-contour are identified by a unique house ID.

The respective coordinates included in the group of coordinates indicated by the contour coordinate information may be represented for example by latitude and longitude. This contour coordinate information is indicative of the group of coordinates by which the planer contour is represented based on the planer contour of the building, which actually exists or once existed, or the parcel of land, which is actually demarcated or was once demarcated. The above-mentioned group of coordinates are determined by reliable data such as field survey data, aerial photograph data, etc., in the same manner as the coordinates of the point indicated by the point-coordinate information, thus being extremely accurate.

FIG. 3(A) is a view illustrating an example of a data structure of contour data of the house-contour and FIB. 3(B) is a view illustrating an example of the house-contour.

As shown in FIG. 3(A), the contour-coordinate information included in the above-described contour data includes the number of coordinate points “n” in the group of coordinates and the respective coordinates (x₀, y₀), (x₁, y₁), . . . , xₙ₋₁, yₙ₋₁) included in the group of coordinates. In case where the house-contour has for example a hexagonal shape, the contour-coordinate information includes the number of coordinates points of “6” and the coordinates of the respective vertexes (x₀, y₀)˜(x₅, y₅). By connecting the vertexes with a line in an address order in a memory in which the respective coordinates have been stored, the contour “L” of the house may be represented as shown in FIG. 3. There may be obtained, through a calculation, the respective coordinates included in the group of coordinates that are placed on the contour “L” of the house, and the respective coordinates included in the group of coordinates that are placed within the inside of the contour “L” of the house.

FIG. 4 is a view illustrating an image in which a position of the house-contour is displayed on a coordinate plane. In an example as shown in FIG. 4, a plurality of house-contours (e.g., “51” to “59” in the figure) is shown. The position of the building or the parcel of land, which is represented by the house-contour, is determined based on the group of coordinates indicated by the respective contour coordinate information.

Now, the function of the arithmetic processing section 2 will be described.

Reading programs (including the map information processing program of the present invention) stored in the ROM, etc. by the CPU to execute them causes the arithmetic processing section 2 to function as a map data reading section 2a (an example of the reading unit), an association judgment section 2b (an example of the association judgment unit), an association information generating section 2c (an example of the association information generating unit), a POI coordinate correction section 2d (an example of the POI coordinate correction unit) and a proration calculation section 2e (an example of the proration calculation unit), so as to carry out a map information processing. Such a map information processing is not always carried out, while displaying the map on the display screen. However, there may be adopted a configuration in which instructions given by an operator through the operation section 3 may be received, while displaying the map on the display screen, where appropriate.

The map data reading section 2a reads the map data M1 and the map data M2 from the storage section 1 into the RAM to carry out the processing under the same environment. In the embodiment of the present invention, both of the coordinate information included in the map data M1 and the coordinate information included in the map data M2 are displayed in the form of latitude-longitude information, and there is no need to carry out a coordinate conversion. In case where the map data M1 and the map data M2 are different from each other in coordinate system, there is however a need to carry out a coordinate conversion so as to provide a coincident coordinate system.

The association judgment section 2b executes a judgment processing to judge, based on the point-coordinate information included in the pinpoint address data in the map data M1 or the POI coordinate information included in the POI data, as well as the contour-coordinate information included in the contour data in the map data M2, as to whether or not an association between the address information corresponding to the above-mentioned point-coordinate information or the POI information corresponding to the above-mentioned POI coordinate information (e.g., the address information and the name information, etc.) and the above-mentioned contour-coordinate information is to be made.

For example, the association judgment section 2b judges as to whether or not the coordinates of the point as indicated by the point-coordinate information are included by the group of coordinates that are placed on the outer edge of the house-contour as obtained based on the contour-coordinate information, or by the group of coordinates that are placed within the inside of the house-contour. In case where the above-mentioned coordinates of the point are included, the association judgment section 2b judges the association between the address information corresponding to the point-coordinate information and the above-mentioned contour-coordinate information to be made. Although some other judgment processing are to be carried out, description of them will be given later.

In case where the association judgment section 2b judges the association to be made, the association information generating section 2c generates association information with which the association between the address information corresponding to the above-mentioned point-coordinate information or the POI information corresponding to the above-mentioned POI coordinate information and the above-mentioned contour-coordinate information is to be made, and then registers the association information on the association information database 11. Such association information includes for example the pinpoint address ID or the ID of the POI, and the contour data ID, etc. for an association.

The POI coordinate correction section 2d corrects the coordinates of the POI as indicated by the POI coordinate information, to permit use of less-accurate POI coordinate information in the above-described judgment processing. Concerning such a correction, there are the correction using the house number included in the pinpoint address data and the house number included in the POI data, as well as the correction using the house number range of the road link and the house number of the POI.

Prior to the correction of the POI coordinate by the POI coordinate correction section 2d using the house number included in the pinpoint address data and the house number included in the POI data, the proration calculation section 2e prorates the house number range of the road link data, which has been associated with the pinpoint address including the above-mentioned house number, based on the house number corresponding to the point-coordinate information included in the pinpoint address data.

Now, an operation of the map information processing apparatus S will be described in the form of Examples Nos. 1 to 5.

### EXAMPLE NO. 1

First, Example No. 1 will be described with reference to FIG. 5. FIGS. 5 and 6 are a flowchart showing an example of a map information processing by an arithmetic processing section 2 in Example No. 1, etc.

In Example No. 1, only the pinpoint address data and the contour data are used. In this case, the pinpoint address data do not include any house number as the address information.

The processing as shown in FIG. 5 starts with for example a start instruction given by an operator through the operation section 3. When the processing starts, the map data reading section 2a of the arithmetic processing section 2 reads the map data M1 and the map data M2 from the storage section 1 (Step S1) to carry out the processing under the same environment.

Then, the arithmetic processing section 2 selects the pinpoint address data and the contour data of the house (Step S2).

Then, the arithmetic processing section 2 calculates the group of coordinates that are placed on the outer edge of the house-contour, as well as the group of coordinates that are placed within the inside of the house-contour, based on the group of coordinates as indicated by the contour coordinate information included in the contour data as selected (Step S3). The group of coordinates that are placed on the outer edge of the house-contour, and the group of coordinates that are placed within the inside of the house-contour are obtained in this manner.

Then, the association judgment section 2b judges as to whether or not the coordinates of the point indicated by the point-coordinate information, which is included in the pinpoint address data as selected in Step S2, are included by the group of coordinates that are placed on the outer edge of the house-contour, and the group of coordinates that are placed within the inside of the house-contour, as obtained in Step S3 (Step S4). More specifically, it is judged as to whether or not the coordinates, which coincide with the coordinates of the point as indicated by the point-coordinate information, are included in the group of coordinates that are placed on the outer edge of the house-contour, and the group of coordinates that are placed within the inside of the house-contour.

FIG. 7 is a view illustrating an example of a relationship between coordinates of a point and the group of coordinates that are placed on an outer edge of the planar contour and within an inside of the planar contour. It is understood from the example as shown in FIG. 7 that the coordinates (xₐ, yₐ) of the point are included in an area of the house-contour as indicated by the respective vertexes (x₀, Y₀)˜(x₅, y₅).

In case where it is judged that the coordinates of the point indicated by the above-mentioned point-coordinate information are included by the group of coordinates that are placed on the outer edge of the house-contour, or the group of coordinates that are placed within the inside of the house-contour (YES in Step S4), the association judgment section 2b judges an association between the address information corresponding to the above-mentioned point-coordinate information and the above-mentioned contour-coordinate information to be made, and causes the system to proceed to Step S5. In case where it is judged that the coordinates of the point indicated by the above-mentioned point-coordinate information are not included by the group of coordinates that are placed on the outer edge of the house-contour, or the group of coordinates that are placed within the inside of the house-contour (NO in Step S4), the processing is terminated.

In Step S5, the association information generating section 2c generates the association information with which the association between the address information corresponding to the above-mentioned point-coordinate information and the above-mentioned contour coordinate information is to be made, and then, registers the generated association information on the association information database 11 (Step S6), and then causes the processing to be terminated. Such association information includes for example at least the pinpoint address and the contour ID.

Even when it is judged that the coordinates of the point are included by the group of coordinates that are placed on the outer edge of the house-contour, or within the inside of the house-contour, a configuration in which the association judgment section 2b judges the contour coordinate information, with which the address information included in the other pinpoint address data has already been associated, not to be associated with the address information, makes it possible to effectively prevent a plurality of address information from being given relative to a single house-contour.

Alternatively, It may be adopted a configuration in which, in case where the association judgment section 2b judges the contour-coordinate information, with which the address information has already been associated, to be associated with the address information, and then a plurality of address information has been associated with a single contour coordinate information, the association of any address information is then released. In such a release of the association, the plurality of address information, which has been associated with the single contour-coordinate information, may selectably be displayed on the display screen and a selection instruction given by an operator through the operation section 3 may release the address information as selected.

The processing as shown in FIG. 5 is carried out for all the combinations of the pinpoint address data and the contour data. After completion of the above-mentioned processing, the processing as shown for example in FIG. 5 starts. After the start of such a processing, the arithmetic processing section 2 specifies the point-coordinate information on the coordinates of the point, which have been judged as not being included by the group of coordinates that are placed on the outer edge of the house-contour, or within the inside of any house-contour (Step S11).

Then, the association judgment section 2b determines a range of the space retrieval, which includes the coordinates of the point indicated in the point-coordinate information as specified (Step S12) and then calculates a group of coordinates included in the above-mentioned range. The range of the space retrieval is for example of a circle area or a rectangular area having the coordinates of the point as a center.

Then, the association judgment section 2b selects the contour data of the house and calculates the group of coordinates that are placed on the outer edge of the house-contour, and the group of coordinates that are placed within the inside of the house-contour, based on the group of coordinates as indicated by the contour coordinate information included in the contour data as selected (Step S13).

Then, the association judgment section 2b judges as to whether or not at least a part of the coordinates of the group of coordinates within the range of the space retrieval as determined is included by the group of coordinates that are placed on the outer edge of the house-contour, or the group of coordinates that are placed within the inside of the house-contour, as obtained in Step S13 (Step S14).

In case where it is judged that at least a part of the coordinates of the group of coordinates within the range of the space retrieval as determined is included by the group of coordinates that are placed on the outer edge of the house-contour, which is indicated by the above-mentioned contour coordinate information, or the group of coordinates that are placed within the inside of the house-contour (YES in Step S14), the association judgment section 2b judges the address information corresponding to the point-coordinate information indicating the coordinates of the point, which serves as the center of the range of the above-mentioned space retrieval, to be associated with the above-described contour coordinate information, and causes the system to proceed to Step S16. In case where it is judged that at least a part of the coordinates of the group of coordinates within the range of the space retrieval as determined is included by neither the group of coordinates that are placed on the outer edge of the house-contour, which is indicated by the above-mentioned contour coordinate information, nor the group of coordinates that are placed within the inside of the house-contour (NO in Step S14), it causes the system to proceed to Step S15.

Even when it is judged that at least a part of the coordinates of the group of coordinates within the range of the space retrieval is included by the group of coordinates that are placed on the outer edge of the house-contour, which is indicated by the above-mentioned contour coordinate information, or the group of coordinates that are placed within the inside of the house-contour, a configuration in which the processing as shown in FIG. 5 causes the association judgment section 2b to judge the contour coordinate information, with which the address information has already been associated, not to be associated with the address information, makes it possible to effectively prevent a plurality of address information from being given relative to a single house-contour. Alternatively, It may be adopted a configuration in which, in case where the association judgment section 2b judges the contour-coordinate information, with which the address information has already been associated, to be associated with the address information, and then a plurality of address information has been associated with a single contour coordinate information, the association of any address information is then released.

In Step S15, the association judgment section 2b judges as to whether or not the number of space retrieval reaches a predetermined number (e.g., five times). The association judgment section 2b judges that the number of space retrieval does not reach the predetermined number (NO in Step S15), it causes the system to return to Step S12, and then determines a range in which the range as determined in the previous space retrieval is expanded by a predetermined amount, in the range including the coordinates of the points as specified, and executes the same processing as described above.

FIG. 8 is a schematic view showing an example of a gradually expanding range of a space retrieval. In the example as shown in FIG. 8, the range H1 is the first space retrieval range, which has an area provided with a center indicated by the coordinates of a point and with a radius “a” (e.g., 1 m). The range H2 is the second space retrieval range, which has an area provided with the center indicated by the coordinates of the point and with a radius “b” (e.g., 5 m). The range H3 is the third space retrieval range, which has an area provided with the center indicated by the coordinates of the point and with a radius “c” (e.g., 10 m). The range of the space retrieval gradually expands in this manner. A gradual expansion of the space retrieval range permits to associate the high-accurate address information with the contour-coordinate information on a priority basis.

In the example as shown in FIG. 8, the group of coordinates placed within the inside of the contour of the house includes the coordinates of the hatched area of the group of coordinates within the space retrieval range H3.

In case where the association judgment section 2b judges that the number of space retrieval reaches a predetermined number (YES in Step S15), it cause the processing to be terminated. In Step S16, the association information generating section 2c generates association information with which the association between the address information corresponding to the point-coordinate information in which the coordinates of the point serving as the center of the above-mentioned space retrieval range are indicated, and the contour-coordinate information including at least part of the coordinates of the group of coordinates within the above-mentioned space retrieval range is to be made, and then registers the association information on the association information database 11 (Step S17) and then causes the processing to be terminated. The above-described processing as shown in FIG. 6 is executed for all the combinations of the contour data of the house with the pinpoint address data, which include the point-coordinate information that have been judged, through the processing as shown in FIG. 5, as being included by neither the group of coordinates that are placed on the outer edge of the house-contour, nor the group of coordinates that are placed within the inside of the house-contour.

According to Example No. 1, there is applied a configuration to generate the association information based on which the association between the address information corresponding to the point-coordinate information and the contour-coordinate information is to be made, in case where the coordinates of the point indicated by the accurate point-coordinate information are included by the group of coordinates that are placed on the outer edge of the house-contour and indicated by the accurate contour coordinate information, or the group of coordinates that are placed within the inside of the house-contour. It is therefore possible to use two kinds of map data to provide the address information for the contour of the house in an effective manner and with a high degree of accuracy, while remarkably minimizing time and cost as required.

In case where at least a part of the coordinates of the group of coordinates within the determined range of the space retrieval is included by the group of coordinates that are placed on the outer edge of the house-contour, or the group of coordinates that are placed within the inside of the house-contour, although the coordinates of the point are not included by the group of coordinates that are placed on the outer edge of the house-contour, or the group of coordinates that are placed within the inside of the house-contour, there is applied a configuration to generate the association information based on which the association between the address information and the contour-coordinate information is to be made. It is therefore possible to provide the address information for the contours of many houses without omission with a relatively high degree of accuracy.

### EXAMPLE NO. 2

Now, Example No. 2 will be described with reference to FIG. 9. FIG. 9 is a flowchart showing an example of a map information processing by an arithmetic processing section 2 in Example No. 2.

In Example No. 2, only the pinpoint address data, the load link data and the contour data are used. In this case, the pinpoint address data do not include any house number as the address information. The processing as shown in FIGS. 5 and 6 is also executed in Example No. 2.

The map data reading section 2a reads the map data M1 and the map data M2 to start the processing as shown in FIG. 9. The start of the processing causes the arithmetic processing section 2 to select the road link data (Step S21).

Then, the arithmetic processing section 2 specifies the pinpoint address data with which the road link data as selected have been associated (Step S22).

The proration calculation section 2e prorates the house number range included in the selected link data, based on the coordinates of the point as indicated by the point-coordinate information included in the specified pinpoint address data (Step S23), and then calculates, based on the prorated house number range” the house number, which is to be included in the specified pinpoint address data (Step S24).

FIG. 10 is a schematic view showing a state in which a house number is assigned to a building or a parcel of land based on house number ranges. In an example as shown in FIG. 10, the house number ranges of from “254” to “200” are prorated by a plurality of sub-ranges (e.g., 254˜248, 248˜242, - - - ). Such a proration calculation is carried out based on a positional relationship of the building or the parcel of land. A respective distance between the coordinate points is determined based on the coordinate points corresponding for example to the respective building, and then prorated in accordance with a ratio of the distance between the respective coordinate points.

Then, the proration calculation section 2e stores the respective house number calculated, as the address information included in the respective pinpoint address data (Step S25) and terminates the processing. The house number is assigned to the contour of the house in this manner.

Such a processing as shown in FIG. 9 is executed for all of the road link data.

After completion of the processing as shown in FIG. 9, the processing as shown in FIG. 5 starts. In this case, the processing as shown in FIG. 9 is executed to cause the house number to be included in the respective pinpoint address data as the address information. In Step S5 as shown in FIG. 5 and Step S16 as shown in FIG. 6, the contour-coordinate information is associated with the house number as the address information.

According to Example No. 2, there is applied a configuration to calculate the house number based on the house number as prorated and include the calculated house number in the pinpoint address data, even when the pinpoint address data do not include the house number. It is therefore possible to use two kinds of map data to provide the contour of the house with the house number with which the building can be inherently identified, in an effective manner and with a high degree of accuracy, while remarkably minimizing time and cost as required, in addition to the same effects provided by Example No. 1.

### EXAMPLE NO. 3

Now, Example No. 3 will be described with reference to FIGS. 11 to 13. FIG. 13 is a flowchart showing an example of a map information processing by an arithmetic processing section 2 in Example No. 3. In Example No. 3, only the pinpoint address data, the POI data and the contour data are used. In this case, the pinpoint address data include the house number as the address information.

For example, a start instruction given by an operator through the operation section 3 starts the operation as shown in FIG. 11. The processing of Steps S31 to S33 as shown in FIG. 11 is the same as the processing of Steps S1 to S3 as shown in FIG. 5.

In case where it is judged in Step S33 that the coordinates of the point is included by the group of coordinates that are placed on the outer edge of the house-contour or the group of coordinates that are placed within the inside of the house-contour (YES in Step S34), the association judgment section 2b causes the system to proceed to Step S35. In case where it is judged that the coordinates of the point is included by neither the group of coordinates that are placed on the outer edge of the house-contour, nor the group of coordinates that are placed within the inside of the house-contour (NO in Step S34), it causes the processing to be terminated. In Step S35, the arithmetic processing section 2 retrieves the POI data associated with the pinpoint address data in which the point coordinate information corresponding to the coordinates of the point as described above are included.

In case where the POI data can be extracted through the above-described retrieval (YES in Step S36), the association judgment section 2b judges as to whether or not the POI information corresponding to the above-described POI coordinate information is to be associated, based on the coordinates of the point, which have been judged as being included in the group of coordinates in Step S34, and the coordinates of the POI as indicated by the POI coordinate information included in the extracted POI data as described above, with the contour-coordinate information corresponding to the group of coordinates including these coordinates of the point, as well as the address information corresponding to the above-described point-coordinate information (Step S37).

The association judgment section 2b judges as to whether or not the POI information is to be associated with the contour-coordinate information as well as the address information, by for example judging as to whether or not the coordinates of the point judged as being included in the group of coordinates in Step S34 coincide with the coordinates of the POI included in the extracted POI data as described above.

In case where the coordinates of the point judged as being included in the group of coordinates in Step S34 are judged as being coincident with the coordinates of the POI included in the extracted POI data as described above (YES in Step S37), the association judgment section 2b generates association information based on which the address information and the POI information are to be associated with the contour-coordinate information as described above (Step S38), and registers the association information on the association information database 11 (Step S39), and then causes the processing to be terminated. Such association information includes for example the pinpoint address ID, the ID of the POI, and the contour data ID.

To the contrary, in case where the POI data cannot be extracted in Step S36 (NO in Step S36) and in case where it is not judged in Step S37 that the POI information together with the address information are to be associated with the contour-coordinate information (NO in Step S37), the system proceeds to Step S40.

In Step S40, the association judgment section 2c generates association information based on which the address information corresponding to the point-coordinate information is to be associated with the contour-coordinate information, in the same manner as Step S5 in Example No. 1, and registers the association information on the association information database 11 (Step S39), and then causes the processing to be terminated.

The processing as shown in FIG. 11 is carried out for all the combinations of the pinpoint address data and the contour data. After completion of the above-mentioned processing, the processing as shown for example in FIG. 12 starts. After the start of such a processing, the arithmetic processing section 2 specifies the POI data, which have been associated with no pinpoint address data (Step S51).

Then, the arithmetic processing section 2 specifies a plurality of pinpoint address data having the house number in which the difference from the house number included in the specified POI data stands within a predetermined value range (namely, placed in the vicinity of it) (Step S52).

Then, the POI coordinate correction section 2d corrects the coordinates of the POI as indicated by the POI coordinate information based on a relationship between the house number included in the respective pinpoint address data as specified and the house number included in the POI data (Step S53). Thus, the coordinates of the POI as indicated by the POI coordinate information included in the POI data are rewritten.

FIG. 14 is a schematic view showing a state in which the coordinates of the POI are corrected based on the house number. In the example as shown in FIG. 14, the POI of the house number “218” is placed between the buildings or the parcels of land “230” and “224” and the position of the POI is not proper. Therefore, the POI coordinate correction section 2d calculates the coordinates, which are assumed as a proper position of the POI and corrects the original coordinates of the POI with the coordinates as calculated. As an image, the position of the POI is shifted as shown in FIG. 14.

Then, the association judgment section 2b selects the contour data of the house and calculates the group of coordinates that are placed on the outer edge of the house-contour, and the group of coordinates that are placed within the inside of the house-contour, based on the group of coordinates as indicated by the contour coordinate information included in the contour data as selected (Step S54).

Then, the association judgment section 2b judges as to whether or not the coordinates of the POI after the correction are included by the group of coordinates that are placed on the outer edge of the house-contour, or the group of coordinates that are placed within the inside of the house-contour, as obtained in Step S54 (Step S55).

In case where it is judged that the coordinates of the POI after the correction are included by the group of coordinates that are placed on the outer edge of the house-contour, or the group of coordinates that are placed within the inside of the house-contour, as obtained in Step S54 (YES in Step S55), the association judgment section 2b judges the POI information including the address information corresponding to the POI coordinate information indicating the coordinates of the POI after the correction to be associated with the contour coordinate information included in the contour data as selected, and causes the system to proceed to Step S56. In case where it is judged that the coordinates of the POI after the correction are included by neither the group of coordinates that are placed on the outer edge of the house-contour, nor the group of coordinates that are placed within the inside of the house-contour (NO in Step S14), it causes the system to be terminated.

Even when it is judged that the coordinates of the POI after the correction are included by the group of coordinates that are placed on the outer edge of the house-contour, or the group of coordinates that are placed within the inside of the house-contour, a configuration in which the processing as shown in FIG. 11 causes the association judgment section 2b to judge the contour coordinate information, with which the POI information has already been associated, not to be associated with the POI information, makes it possible to effectively prevent a plurality of POI information from being given relative to a single house-contour. Alternatively, It may be adopted a configuration in which, in case where the association judgment section 2b judges the contour-coordinate information, with which the POI information has already been associated, to be associated with the POI information, and then a plurality of POI information has been associated with a single contour coordinate information, the association of any POI information is then released. In such a release of the association, the plurality of POI information, which has been associated with the single contour-coordinate information, may selectably be displayed on the display screen and a selection instruction given by an operator through the operation section 3 may release the POI information as selected.

In Step S56, the association information generating section 2c generates association information with which the association between the POI information including the address information corresponding to the POI coordinate information indicating the coordinates of the POI after the correction, and the contour coordinate information included in the contour data as selected is to be made, and then registers the association information on the association information database 11 (Step S57) and then causes the processing to be terminated.

The above-described processing as shown in FIG. 12 is executed for all the combinations of the POI data including the corrected POI coordinate information with the contour data. After completion of this processing, the processing as shown for example in FIG. 13 starts. After starting the processing as shown in FIG. 13, the arithmetic processing section 2 specifies the POI coordinate information indicating the coordinates of the POI after the correction, which have been judges as being included by neither the group of coordinates that are placed on the outer edge of the house-contour, nor the group of coordinates that are placed within the inside of the house-contour (Step S61).

Then, the arithmetic processing section 2 determines a range of the space retrieval, which includes the corrected coordinates of the POI indicated in the POI coordinate information as specified (Step S62) and then calculates a group of coordinates included in the above-mentioned range. The range of the space retrieval is the same as Example No. 1.

Then, the association judgment section 2b selects the contour data of the house and calculates the group of coordinates that are placed on the outer edge of the house-contour, and the group of coordinates that are placed within the inside of the house-contour, based on the group of coordinates as indicated by the contour coordinate information included in the contour data as selected (Step S63).

Then, the association judgment section 2b judges as to whether or not at least a part of the coordinates of the group of coordinates within the range of the space retrieval as determined is included by the group of coordinates that are placed on the outer edge of the house-contour, or the group of coordinates that are placed within the inside of the house-contour, as obtained in Step S62 (Step S64).

In case where it is judged that at least a part of the coordinates of the group of coordinates within the range of the space retrieval as determined is included by the group of coordinates that are placed on the outer edge of the house-contour, or the group of coordinates that are placed within the inside of the house-contour (YES in Step S64), the association judgment section 2b judges the POI information including the address information corresponding to the POI coordinate information indicating the corrected coordinates of the POI, which serves as the center of the range of the above-mentioned space retrieval, to be associated with the above-described contour coordinate information included in the contour data as selected, and causes the system to proceed to Step S66. In case where it is judged that at least a part of the coordinates of the group of coordinates within the range of the space retrieval as determined is included by neither the group of coordinates that are placed on the outer edge of the house-contour, nor the group of coordinates that are placed within the inside of the house-contour (NO in Step S64), it causes the system to proceed to Step S65.

Even when it is judged that at least a part of the coordinates of the group of coordinates within the range of the space retrieval as determined is included by the group of coordinates that are placed on the outer edge of the house-contour, or the group of coordinates that are placed within the inside of the house-contour, a configuration in which the processing as shown in FIG. 11 or 12 causes the association judgment section 2b to judge the contour coordinate information, with which the POI information has already been associated, not to be associated with the POI information, makes it possible to effectively prevent a plurality of address information from being given relative to a single house-contour. Alternatively, It may be adopted a configuration in which, in case where the association judgment section 2b judges the contour-coordinate information, with which the POI information has already been associated, to be associated with the POI information, and then a plurality of POI information has been associated with a single contour coordinate information, the association of any POI information is then released.

In Step S65, the association judgment section 2b judges as to whether or not the number of space retrieval reaches a predetermined number (e.g., five times). The association judgment section 2b judges that the number of space retrieval does not reach the predetermined number (NO in Step S65), it causes the system to return to Step S12, and then determines a range in which the range as determined in the previous space retrieval is expanded by a predetermined amount, in the range including the coordinates of the points as specified, and executes the same processing as described above.

In case where the association judgment section 2b judges the number of space retrieval as reaching a predetermined number (YES in Step S65), this section causes the processing to be terminated.

In Step S66, the association information generating section 2c generates association information with which the association between the POI information including the address information corresponding to the POI coordinate information indicating the coordinates of the POI after the correction, serving as the center of the above-mentioned space retrieval range, and the contour-coordinate information as described above is to be made, and then registers the association information on the association information database 11 (Step S67) and then causes the processing to be terminated.

The processing as shown in FIG. 13 is carried out for all the combinations of the POI data including the POI coordinate information indicating the coordinates of the POI ass corrected through the processing as shown in FIG. 12, and the contour data.

According to Example No. 3, there is applied a configuration in which it is judged as to whether or not the POI information and the address information are to be associated with the contour-coordinate information, based on the coordinates of the point as indicated by the point-coordinate information and the coordinates of the POI as indicated by the POI coordinate information, and in case where it is judges the association to be made, the association information with which the address information and the POI information are to be associated with the contour-coordinate information. It is therefore possible to use two kinds of map data to provide the contour of the house with the more useful POI information together with the address information, in an effective manner, while remarkably minimizing time and cost as required, in addition to the same effects provided by Example No. 1.

The coordinates of the POI as indicated by the POI coordinate information is corrected based on a relationship between the house number corresponding to the point-coordinate information and the house number corresponding to the POI coordinate information to provide a high accuracy. In case where the corrected coordinates of the POI are included by the group of coordinates that are placed on the outer edge of the house-contour, or the group of coordinates that are placed within the inside of the house-contour, the POI information corresponding to the POI coordinate information as corrected is associated with the contour-coordinate information. Even if the coordinates of the point are included by neither the group of coordinates that are placed on the outer edge of the house-contour, nor the group of coordinates that are placed within the inside of the house-contour, it is possible to use the POI coordinate information having a relatively low accuracy to provide the contour of the house with the more useful POI information together with the address information, in an effective manner and with a relatively high degree of accuracy, while remarkably minimizing time and cost as required. More specifically, it is possible to effectively utilize the POI coordinate information having a relatively low accuracy.

In addition, there is adopted a configuration in which, even if the corrected coordinates of the POI are included by neither the group of coordinates that are placed on the outer edge of the house-contour, nor the group of coordinates that are placed within the inside of the house-contour, the fact that at least a part of the coordinates of the group of coordinates within the range as decided of the space retrieval is included by the group of coordinates that are placed on the outer edge of the house-contour, which is indicated by the above-mentioned contour coordinate information, or the group of coordinates that are placed within the inside of the house-contour, causes the association information with which the association between the POI information including the address information and the contour-coordinate information is to be made, to be generated. It is therefore possible to provide the useful POI information together with the address information for the contours of many houses without omission with a relatively high degree of accuracy.

### EXAMPLE NO. 4

Now, Example No. 4 will be described with reference to FIG. 15. FIG. 15 is a flowchart showing an example of a map information processing by an arithmetic processing section 2 in Example No. 4.

In Example No. 4, all of the pinpoint address data, the load link data, the POI data and the contour data of the house are used. In this case, the pinpoint address data include a house number as the address information.

The processing as shown in FIGS. 5, 6 and 13 is also executed in Example No. 4.

The processing as shown in FIG. 15 starts after the completion of the processing as shown for example in FIGS. 5 and 6. When the processing starts, the arithmetic processing section 2 specifies the POI data, which have not been addressed with any pinpoint address data (Step S71).

Then, the arithmetic processing section 2 specifies the load link data with which the POI data as specified have been associated (Step S72).

Then, the arithmetic processing section 2 specifies the pinpoint address data with which the load link data as specified have been associated (Step S73).

Then, the proration calculation section 2e prorates the house number range of the load link data as specified, based on the house number included in the pinpoint address data as specified (Step S74).

FIG. 16 is a schematic view showing a state in which the house number range is prorated. The proration calculation of the house number range is executed based on the house number of a building or a parcel of land, in accordance with the position of the building or the parcel of land corresponding to the respective pinpoint address data associated with the load link data.

Then, the POI coordinate correction section 2d corrects the coordinates of the POI as indicated by the POI coordinate information included in the POI data, based on a relationship between the house number range as prorated and the house number included in the above-mentioned POI data (Step S75). Thus, the coordinates of the POI as indicated by the POI coordinate information included in the POI data are rewritten.

FIG. 17 is a schematic view showing a state in which the coordinates of the POI are corrected. In the example as shown in FIG. 17, the POI of the house number “218” is placed between “230” and “224” of the house number ranges as prorated and the position of the POI is not proper. Therefore, the POI coordinate correction section 2d calculates the coordinates, which are assumed as a proper position of the POI and corrects the original coordinates of the POI with the coordinates as calculated.

The processing of Steps S76 to S79 as shown in FIG. 15 is the same as the processing of Steps S54 to S57.

Then, the processing as shown in FIG. 13 is carried out.

FIG. 18 is a view showing an example of information registered on an association information database 11. In the example as shown in FIG. 18, there is made an association of the ID of the house-contour, the contour-coordinate information, the pinpoint address ID, the point-coordinate information, the ID of the POI, the POI coordinate information, the address information and the POI information. The association may be made with only the ID.

According to Example 4, there is applied a configuration in which the house number range included in the load link data is prorated based on the house number corresponding to the point coordinate information to correct the coordinates of the POI based on the relationship between the prorated range and the house number corresponding to the POI coordinate information. It is therefore possible to correct, in addition to the same effects provided by Example No. 3, the coordinates of the POI with a higher degree of accuracy than Example No. 3. As a result, the POI coordinate information having a low accuracy may be utilized to provide the contour of the house with the more useful POI information together with the address information, with a relatively high degree of accuracy. More specifically, it is possible to effectively utilize the POI coordinate information having a relatively low accuracy.

According to Example Nos. 2 and 3 as described above, the address information is associated with the house-contour through multiple stages, and the address information may be associated with more house-contours with a higher degree of accuracy. In addition, the association information is generated in the order of generation of high-accurate association information. Even if a plurality of address information exists as being provided for a single house-contour, it is possible to provide the above-mentioned house-contour with the high-accurate address information on a preferential basis.

### EXAMPLE NO. 5

The processing processes as shown in FIGS. 5, 6, 15 and 13 are described as being carried out in series in Example No. 4 as described above. However, in Example No. 5, the processing processes as shown in FIGS. 5, 6, 15 and 13 are carried out in parallel.

More specifically, there are carried out in parallel (1) the processing to judge as to whether or not the coordinates of the point are included by the group of coordinates that are placed on the outer edge of the house-contour, or by the group of coordinates that are placed within the inside of the house-contour, (2) the processing to judge as to whether or not at least a part of the coordinates of the group of coordinates within the predetermined range is included by the group of coordinates that are placed on the outer edge of the house-contour, or the group of coordinates that are placed within the inside of the house-contour, (3) the processing to judge as to whether or not the corrected coordinates of the POI are included by the group of coordinates that are placed on the outer edge of the house-contour, or the group of coordinates that are placed within the inside of the house-contour, and (4) the processing to judge as to whether or not at least a part of the coordinates of the group of coordinates within the predetermined range including the corrected coordinates of the POI is included by the group of coordinates that are placed on the outer edge of the house-contour, or the group of coordinates that are placed within the inside of the house-contour.

Such a parallel processing may be achieved by using for example a multi-core processor (a plurality of CPUs) or a distributed (memory) computer.

In case where a plurality of address information or a plurality of POI information are associated with the single contour-coordinate information in such a parallel processing, the arithmetic processing section 2 releases, in accordance with the instructions given by an operator through the operation section 3, the association of the address information or the POI information, and leaves only the single address information of the single POI information.

According to Example No. 5, there is no need to monitor the respective processing states and the processing results, and it is possible to provide rapidly a large number of house-contours with the address information with a high degree of accuracy.

According to the embodiments of the present invention as described above, the map information processing apparatus S reads the map data M1 and the map data M2 and judges, based on the point-coordinate information, as included in the map data M1, indicative of the coordinates of the point by which the position of the building or the parcel of land is represented as a dot, as well as the contour-coordinate information, as included in the map data M2, indicative of a group of coordinates by which the house-contour is represented, as to whether or not the association between the address information corresponding to the point-coordinate information and the contour-coordinate information. In case where it is judged that the association is to be made, there is generated the association information based on which the association between the address information corresponding to the above-mentioned point-coordinate information and the above-mentioned contour-coordinate information is to be made. It is therefore possible to use two kinds of map data to provide the address information for the contour of the house in an effective manner and with a high degree of accuracy, while remarkably minimizing time and cost as required.

Further, the point-coordinate information is indicative of the coordinates of the point by which the position is represented as the dot based on the position of the building, which actually exists or once existed, or the parcel of land, which is actually demarcated or was once demarcated, and the contour coordinate information is indicative of the group of coordinates by which the planer contour is represented based on the planer contour of the building, which actually exists or once existed, or the parcel of land, which is actually demarcated or was once demarcated. The point-coordinate information and the contour-coordinate information are both extremely accurate in position, and it is judged, based on the accurate point-coordinate information and the accurate contour-coordinate information, as to whether or not the association is to be made, thus making it possible to make the association between the address information corresponding to the point-coordinate information and the house-contour presented by the contour-coordinate information, with a higher degree of accuracy.

In addition, there is a configuration in which the address information that is given to the house-contour is the house number as calculated based on the house number range of the road link data with which the above-mentioned address information is to be associated. It is therefore possible to provide the house-contour having an extremely high accuracy of position with the house number with which with which the building may peculiarly be identified.

Even when the map data having the association information as generated are supplied to a client's terminal for example from a map information web site (server) in the United States of America, a user may retrieve a certain house-contour by inputting the address.

In the embodiments as described above, use of the map data having the association information as generated enables a more valuable information to be displayed on the map supplied from for example a map information web site to a client's terminal.

If a detailed layout or yard map of facilities such as a shopping mall, an airport and a railroad station is registered as the POI information associated with the house contour of such a facility, a selection of the house contour displayed on the map by a user enables the layout or yard map to be displayed on or in the vicinity of the house contour. In addition, if a name of the shopping mall and/or tenant information are registered as the POI information, these information may be displayed along with or separately from the detailed layout, etc. as described above.

It may be adopted a configuration in which, in case where a user has given instructions on for example making an area search on the map, the house contour is displayed with a specific color on the display screen so as to be distinguishable based on a genre (a category) of the POI associated with the house contour. For example, the house contour in which the genre of the POI is “restaurant”, is displayed with a different color (for example, in red) from the other house contour.

Only the house contours relating to “tourist spots” such as museums, historic buildings, etc. may be displayed in a highlighted manner based on for example a genre (a category) of the POI associated with the house contour, and a selection of the corresponding house contour may cause description of such building to be displayed on or in the vicinity of the house contour. In an alternative example, the house contour of the facilities such as a restaurant may be displayed with different colors during opening or outside hours of the facility. The house contour of for example a restaurant where breakfasts may be served at 7:00 AM or a place where a user can get some coffee at 7:00 AM, may be displayed with a specific color. Only the house contours associated with the POI concerning a field or category, which has previously been registered as the interested items, may be displayed with a specific color.

The house contour data may be associated with for example a service information concerning this house contour, which is available from a site on the internet, and such a service information may be displayed in the vicinity of the house contour. For example, in case where the facilities corresponding to the house contour is a “restaurant” or a “retail shop” that sells some products, information (e.g., a discount information or a coupon ticket) on the restaurant or retail shop specified by a URL of a site for such a restaurant or retail shop may be displayed in the vicinity of the house contour, when the above-mentioned house contour is selected. When the facilities corresponding to the house contour is a “movie theater”, a program of a currently playing movie in this theatre may be displayed. When the facilities corresponding to the house contour is a “ball stadium”, a bracket or a screen for purchasing a ticket may be displayed.

In addition, three-dimensional data provided on the house contour may be used in combination, and information on tenants of a building corresponding to the house contour may be displayed together with a name of the building.

In case where the POI associated with the house contour includes the number of floors, the number of a the highest floor of all the POIs associated with the building has previously registered in the POI data, and a height of the building may be given in a simplified manner by multiplication of the number of floors and “??”m, thus creating a simple 3D map.

The map data as created by the map information processing apparatus S according to the embodiments of the present invention may be utilized by the other apparatus such as a navigation apparatus or a search apparatus for the map, than the apparatus as described above.

1. A map information processing apparatus comprising:
a reading unit that reads first map data comprising address information indicative of an address of a building or a parcel of land, and point-coordinate information indicative of coordinates of a point by which a position of the building or the parcel of land is represented as a dot; and second map data comprising contour-coordinate information indicative of a group of coordinates by which a planar contour of the building or the parcel of land is represented;
an association judgment unit that judges, based on said point-coordinate information included in the first map data and said contour-coordinate information included in the second map data, as to whether or not an association between said address information corresponding to said point-coordinate information and said contour-coordinate information is to be made; and
an association information generating unit that generates association information based on which the association between the address information corresponding to the point-coordinate information and the contour-coordinate information is to be made, in case where the association judgment unit judges the association to be made, and wherein:
said first map data comprises a road link information including a house number range information indicative of a range of a house number; POI (Point Of Interest) information including address information indicative of an address of a POI; and POI coordinate information indicative of coordinates of the POI by which a position of the POI is represented as a dot; and
said map information processing apparatus further comprises:
a proration calculating unit that prorates, based on the house number included in said address information corresponding to said point-coordinate information, the range of the house number included in said road link information associated with said address information; and
a coordinate correction unit that corrects, based on a relationship between said range as prorated and the house number included in said address information of said POI, the coordinates of the POI as indicated based on the POI coordinate information corresponding to said POI.

2. The map information processing apparatus as claimed in claim 1, wherein:
said point-coordinate information is indicative of the coordinates of the point by which said position is represented as the dot based on a position of the building, which actually exists or once existed, or the parcel of land, which is actually demarcated or was once demarcated; and
said contour-coordinate information is indicative of the group of coordinates by which said planar contour is represented based on said planar contour of the building, which actually exists or once existed, or the parcel of land, which is actually demarcated or was once demarcated.

3. The map information processing apparatus as claimed in claim 1, wherein:
said association judgment unit judges as to whether or not the coordinates of the point as indicated based on said point-coordinate information are included by the group of coordinates that are placed on an outer edge of the planar contour as obtained based on said contour-coordinate information, or by the group of coordinates that are placed within an inside of the planar contour, and judges, in case where said coordinates of the point are included, the association between said address information and said contour-coordinate information to be made.

4. The map information processing apparatus as claimed in claim 1, wherein:
said association judgment unit judges as to whether or not at least partial coordinates of a group of coordinates within a predetermined range, which includes said coordinates of the point that have been judged as neither being included by the group of coordinates that are placed on the outer edge of said planar contour as obtained based on said contour-coordinate information, and as nor being included by the group of coordinates that are placed within the inside of the planar contour, are included by the group of coordinates that are placed on the outer edge of the planar contour as obtained based on the group of coordinates indicated based on said contour-coordinate information, or by the group of coordinates that are placed within the inside of the planar contour, and judges, in case where said at least partial coordinates are included, the association between said address information and said contour-coordinate information that comprises the at least partial coordinates of the group of coordinates within said predetermined range.

5. The map information processing apparatus as claimed in claim 1, wherein:
said first map data comprises a road link information including a house number range information indicative of a range of a house number; and
said address information comprises a house number as obtained based on said house number range information, which is to be included by the road link information with which said address information is to be associated.

6. The map information processing apparatus as claimed in claim 1, wherein:
said first map data comprises POI (Point Of Interest) information including name information indicative of a name of a POI; and POI coordinate information indicative of coordinates of the POI by which a position of the POI is represented as a dot;
said association judgment unit judges, based on the coordinates of the point as indicated based on said point-coordinate information and the coordinates of the POI as indicated based on said POI coordinate information, as to whether or not the POI information corresponding to said POI coordinate information is to be associated with said contour-coordinate information as well as said address information corresponding to said point-coordinate information; and
said association information generating unit generates, in case where said association judgment unit has judged the association to be made, the association information based on which said address information and said POI information are to be associated with said contour-coordinate information.

7. The map information processing apparatus as claimed in claim 1, wherein:
said first map data comprises POI (Point Of Interest) information including address information indicative of an address of a POI; and POI coordinate information indicative of coordinates of the POI by which a position of the POI is represented as a dot; and
said map information processing apparatus further comprises a coordinate correction unit that corrects, based on a relationship between said address information corresponding to said point-coordinate information and said address information corresponding to said POI coordinate information, the coordinates of the POI indicated based on said POI coordinate information.

8. (canceled)

9. The map information processing apparatus as claimed in claim 7, wherein:
said association judgment unit judges as to whether or not the coordinates of the POI as corrected are included by the group of coordinates that are placed on an outer edge of the planar contour as obtained based on the group of coordinates as indicated based on said contour-coordinate information, or by the group of coordinates that are placed within an inside of the planar contour, and judges, in case where said coordinates of the POI are included, the association between said POI information corresponding to said POI coordinate information and said contour-coordinate information to be made.

10. The map information processing apparatus as claimed in claim 7, wherein:
said association judgment unit judges as to whether or not at least partial coordinates of a group of coordinates within a predetermined range, which includes said coordinates as corrected of the POI that have been judged as neither being included by the group of coordinates that are placed on the outer edge of said planar contour as obtained based on said contour-coordinate information, and as nor being included by the group of coordinates that are placed within the inside of the planar contour, are included by the group of coordinates that are placed on the outer edge of the planar contour as obtained based on the group of coordinates indicated based on said contour-coordinate information, or by the group of coordinates that are placed within the inside of the planar contour, and judges, in case where said at least partial coordinates are included, the association between said POI information corresponding to said POI coordinate information and said contour-coordinate information that comprises the at least partial coordinates of the group of coordinates within said predetermined range.

11. The map information processing apparatus as claimed in claim 9, wherein:
said POI information includes name information indicative of a name of the POI.

12. The map information processing apparatus as claimed in claim 6 1, further comprises:
a release unit that releases, in case where a plurality of said POI information have been associated with a single contour-coordinate information, any of the associations of said POI information.

13. The map information processing apparatus as claimed in claim 1, wherein:
said second map data comprises a plurality of contour-coordinate information;
a processing to judge as to whether or not the association between said address information and said contour-coordinate information is to be made, using the association judgment unit that judges as to whether or not the coordinates of the point as indicated based on said point-coordinate information are included by the group of coordinates that are placed on an outer edge of the planar contour as obtained based on said contour-coordinate information, or by the group of coordinates that are placed within an inside of the planar contour, and judges, in case where said coordinates of the point are included, the association between said address information and said contour-coordinate information to be made,
a processing to judge as to whether or not the association between said address information and said contour-coordinate information is to be made, using the association judgment unit that judges as to whether or not at least partial coordinates of a group of coordinates within a predetermined range, which includes said coordinates of the point that have been judged as neither being included by the group of coordinates that are placed on the outer edge of said planar contour as obtained based on said contour-coordinate information, and as nor being included by the group of coordinates that are placed within the inside of the planar contour, are included by the group of coordinates that are placed on the outer edge of the planar contour as obtained based on the group of coordinates indicated based on said contour-coordinate information, or by the group of coordinates that are placed within the inside of the planar contour, and judges, in case where said at least partial coordinates are included, the association between said address information and said contour-coordinate information that comprises the at least partial coordinates
of the group of coordinates within said predetermined range, and
a processing to judge as to whether or not the association between said address information and said contour-coordinate information is to be made, using the association judgment unit that judges as to whether or not the coordinates of the POI as corrected are included by the group of coordinates that are placed on an outer edge of the planar contour as obtained based on the group of coordinates as indicated based on said contour-coordinate information, or by the group of coordinates that are placed within an inside of the planar contour, and judges, in case where said coordinates of the POI are included, the association between said POI information corresponding to said POI coordinate information and said contour-coordinate information to be made,
are carried out in series; and
the association judgment unit does not judge, in the respective processing for judgment, the address information to be associated with said contour-coordinate information with which said address information has already been associated.

14. The map information processing apparatus as claimed in claim 1, wherein:
said second map data comprises a plurality of contour-coordinate information;
a processing to judge as to whether or not the association between said address information and said contour-coordinate information is to be made, using the association judgment unit that judges as to whether or not the coordinates of the point as indicated based on said point-coordinate information are included by the group of coordinates that are placed on an outer edge of the planar contour as obtained based on said contour-coordinate information, or by the group of coordinates that are placed within an inside of the planar contour, and judges, in case where said coordinates of the point are included, the association between said address information and said contour-coordinate information to be made,
a processing to judge as to whether or not the association between said address information and said contour-coordinate information is to be made, using the association judgment unit that judges as to whether or not at least partial coordinates of a group of coordinates within a predetermined range, which includes said coordinates of the point that have been judged as neither being included by the group of coordinates that are placed on the outer edge of said planar contour as obtained based on said contour-coordinate information, and as nor being included by the group of coordinates that are placed within the inside of the planar contour, are included by the group of coordinates that are placed on the outer edge of the planar contour as obtained based on the group of coordinates indicated based on said contour-coordinate information, or by the group of coordinates that are placed within the inside of the planar contour, and judges, in case where said at least partial coordinates are included, the association between said address information and said contour-coordinate information that comprises the at least partial coordinates of the group of coordinates within said predetermined range, and
a processing to judge as to whether or not the association between said address information and said contour-coordinate information is to be made, using the association judgment unit that judges as to whether or not the coordinates of the POI as corrected are included by the group of coordinates that are placed on an outer edge of the planar contour as obtained based on the group of coordinates as indicated based on said contour-coordinate information, or by the group of coordinates that are placed within an inside of the planar contour, and judges, in case where said coordinates of the POI are included, the association between said POI information corresponding to said POI coordinate information and said contour-coordinate information to be made,
are carried out in parallel; and
said map information processing apparatus further comprises a release unit that releases, in case where a plurality of said POI information have been associated with a single contour-coordinate information, any of the associations of said POI information.

15. A map information processing method comprising the steps of:
reading first map data comprising address information indicative of an address of a building or a parcel of land, and point-coordinate information indicative of coordinates of a point by which a position of the building or the parcel of land is represented as a dot; and second map data comprising contour-coordinate information indicative of a group of coordinates by which a planar contour of the building or the parcel of land is represented;
judging, based on said point-coordinate information included in the first map data and said contour-coordinate information included in the second map data, as to whether or not an association between said address information corresponding to said point-coordinate information and said contour-coordinate information is to be made; and
generating association information based on which the association between the address information corresponding to the point-coordinate information and the contour-coordinate information is to be made, in case where the association judgment unit judges the association to be made, and wherein:
said first map data comprises a road link information including a house number range information indicative of a range of a house number; POI (Point Of Interest) information including address information indicative of an address of a POI; and POI coordinate information indicative of coordinates of the POI by which a position of the POI is represented as a dot; and
said map information processing method further comprises the steps of:
prorating, based on the house number included in said address information corresponding to said point-coordinate information, the range of the house number included in said road link information associated with said address information; and
correcting, based on a relationship between said range as prorated and the house number included in said address information of said POI, the coordinates of the POI as indicated based on the POI coordinate information corresponding to said POI.

16. A non-transitory computer-readable recording medium storing a map information processing program, which causes a computer to execute the steps of:
reading first map data comprising address information indicative of an address of a building or a parcel of land, and point-coordinate information indicative of coordinates of a point by which a position of the building or the parcel of land is represented as a dot; and second map data comprising contour-coordinate information indicative of a group of coordinates by which a planar contour of the building or the parcel of land is represented;
judging, based on said point-coordinate information included in the first map data and said contour-coordinate information included in the second map data, as to whether or not an association between said address information corresponding to said point-coordinate information and said contour-coordinate information is to be made; and
generating association information based on which the association between the address information corresponding to the point-coordinate information and the contour-coordinate information is to be made, in case where the association judgment unit judges the association to be made, and wherein:
said first map data comprises a road link information including a house number range information indicative of a range of a house number; POI (Point Of Interest) information including address information indicative of an address of a POI; and POI coordinate information indicative of coordinates of the POI by which a position of the POI is represented as a dot; and
said map information processing program further causes a computer to execute the steps of:
prorating, based on the house number included in said address information corresponding to said point-coordinate information, the range of the house number included in said road link information associated with said address information; and
correcting, based on a relationship between said range as prorated and the house number included in said address information of said POI, the coordinates of the POI as indicated based on the POI coordinate information corresponding to said POI.

17. (canceled)
